(19) United States
(12) Patent Application Publication
(10) Pub. No.: US 2025/0208985 A1
(43) Pub. Date: Jun. 26, 2025

(54) METHOD AND SYSTEM FOR PROVISIONING CROSS-DOMAIN TEST

(71) Applicant: WOVEN BY TOYOTA, INC., Tokyo (JP)

(72) Inventors: Beck CHEN, Tokyo (JP); Jake ROONEY, Tokyo (JP); Brandon FULLJAMES, Tokyo (JP); Patrick HESPE, Tokyo (JP); Ryo NAKAO, Tokyo (JP); Anthony SUTERA, Tokyo (JP); Ming CHEN, Tokyo (JP); Fredrik LINDERVALL, Tokyo (JP); Hannah CO, Tokyo (JP); Cyril COURTOY, Palo Alto, CA (US)

(73) Assignee: WOVEN BY TOYOTA, INC., Tokyo (JP)

(21) Appl. No.: 18/392,599

(22) Filed: Dec. 21, 2023

(51) Int. Cl. G06F 11/36

(52) U.S. Cl. CPC G06F 11/3688; G06F 11/3684; G06F 11/3692

(57) ABSTRACT

Provided are a method, system, and device for facilitating provisioning of a cross-domain test for testing software of an embedded system. According to embodiments, the method may be implemented by at least one processor and may include: detecting a change in the software; obtaining a test configuration file associated with the software; obtaining, based on the test configuration file, a test bench; determining a plurality of test environments associated with the test bench; and performing the cross-domain test based on the plurality of test environments, wherein the software of the embedded system may include an in-vehicle electronic control unit (ECU), and wherein the plurality of tests environments may include at least one software-in-the-loop (SIL) test environment, and at least one hardware-in-the-loop (HIL) test environment.

### TECHNICAL FIELD

Systems and methods consistent with example embodiments of the present disclosure relate to testing provisioning, and more particularly, relate to systems and methods for provisioning different simulations and/or test environments for a cross-domain test.

### BACKGROUND

In the related art, various test environments have been introduced to test functionality and software performance of a system. By way of example, an embedded system of a vehicle, such as an electronic control unit (ECU), may be tested by utilizing, among others, at least one software-in-the-loop (SIL) test environment and at least one hardware-in-the-loop (HIL) test environment.

In order to develop advanced or complex features in a system, testing of functionality and performance of multiple software and hardware components across multiple systems or domains is required. In the context of vehicle systems, a cross-domain test may be required during development of advanced features in a vehicle system, such as Lane Change Assist, Mobile Smart Keys, and the like, and the cross-domain test may involve testing the interaction between different ECUs and the associated software and hardware components.

Simply put, a cross-domain test may refer to a testing that involves testing the functionality of the components across different domains or environments, such as different operating environments, different system configurations, different hardware and/or software configurations, and/or the like. The purpose of a cross-domain test is to ensure that the system components function correctly across all of these domains under different circumstances.

Accordingly, a cross-domain test may have the following characteristics: (1) the cross-domain test often experiences integration challenges, since a minor change in an ECU may significantly affect functionalities and stability of other associated ECUs and the associated components, and may require careful integration management among the components of the system; (2) the cross-domain test often experiences test environment constraints, since the cross-domain test may require specific hardware, software, and/or system configuration, and it may be challenging or time-consuming to set up and maintain a test environment that accurately fulfill the testing requirements; and (3) the cross-domain test often experiences complexity in communication and collaboration among the users, since the cross-domain test often involves multiple users (e.g., teams, stakeholders, vehicle manufacturers, suppliers, vendors, etc.) who may locate at different locations and may have different priorities, goals, backgrounds, communication styles, or the like, and thus effective communication and collaboration are required in order to perform an accurate cross-domain test.

In view of the above, whenever a cross-domain test is required in the related art, the multiple ECUs and associated software/hardware components are required to be collectively deployed in a centralized testing facility (e.g., a local simulation/testing facility, etc.), where the users/testers physically visit and perform the cross-domain test therein. Nevertheless, the approaches for performing a cross-domain test in the related art have at least the following shortcomings.

Firstly, it is burdensome and time-consuming for the users to physically visit the testing facility. For instance, the users may locate at a geographical location(s) different from the testing facility (e.g., different regions, different countries, etc.), thus physically visiting the testing facility may require proper planning and may be costly (e.g., the users may require to take a long flight to the testing facility, may require to properly collaborate with other associated users to schedule the test and reserve the testing facility accordingly, may require to apply for visiting Visa and/or permit which may be time consuming for getting approval, etc.). In addition, since the available equipment, hardware, or the like, in the testing facility are limited, the users usually need to wait for a long time (e.g., be placed in a waiting list, etc.) before being able to utilize the testing facility to perform the cross-domain test.

Further, in the related art, it is difficult to quickly and accurately identify or discover a breaking change(s) during the cross-domain test. Specifically, since multiple components in the local testing facility may be changed (e.g., in addition to a component under-test, an associated component(s) may also be changed) after being utilized by different users, if the configurations of the components are not being restored to the required state, the cross-domain test performed based on the multiple changed components may not be accurate and the users may not be able to quickly and accurately identify the breaking change(s) through the cross-domain test (e.g., an issue caused by a changes in the component under-test may be discovered in the cross-domain test but may be misinterpreted by the users as an issue caused by the changes in other components, the issue may not be discovered since it is remedied by the changes in other components, etc.).

Furthermore, in the related art, the configuration of the testing facility is not flexible and the cross-domain test is difficult to be reconfigured on-the-fly or on-demand. For instance, whenever the users/testers want to add a new ECU(s) or change the ECU(s) involved in the testing facility, but the requested ECU(s) is not immediately available, the users/testers may need to again reserve the testing facility, wait for the scheduled next testing, and revisit the testing facility for the further testing thereafter. Thus, in the related art, even if a breaking change(s) is being discovered during the cross-domain test, it is difficult to immediately remedy the breaking change(s) on the spot upon discovery and re-run the test immediately thereafter.

In view of the above, performing a cross-domain test in the related art is time consuming, majority of the time are being spent on trip arrangement, traveling, waiting for turns for testing, and the like. As a result, the approaches for performing a cross-domain test in the related art is inefficient, the cross-domain test in the related art is not able to be executed on-demand, executing the cross-domain test is burdensome for the users, and a breaking change(s) of a component under-test is difficult to be discovered and be immediately remedied. Ultimately, these may result in long lead time from system on chip (SoC) specification to vehicle start of production (SOP).

### SUMMARY

According to embodiments, methods, systems, and devices are provided for automatically facilitating a cross-domain test for testing one or more software of a system. For instance, the methods, systems, and devices may automatically determine whether or not a test execution should be triggered, may automatically determine appropriate test environments for performing the cross-domain test, and may automatically perform the cross-domain test thereon.

According to embodiments, a method for facilitating provisioning of a cross-domain test for testing software of an embedded system may be provided. The method may be implemented by at least one processor, and may include: detecting a change in the software; obtaining a test configuration file associated with the software; obtaining, based on the test configuration file, a test bench; determining a plurality of test environments associated with the test bench; and performing the cross-domain test based on the plurality of test environments, wherein the software of the embedded system may include an in-vehicle electronic control unit (ECU), and wherein the plurality of tests environments may include at least one software-in-the-loop (SIL) test environment and at least one hardware-in-the-loop (HIL) test environment.

According to embodiments, the test configuration file may include information of a plurality of ECUs associated with the software and information of a test environment associated with each of the plurality of ECUs. At least a portion of the plurality of ECUs may be associated with one or more nodes different from the software. Further, at least a portion of the plurality of ECUs may be distributed across geographical locations different from the software. Furthermore, the plurality of ECUs may include: at least one virtual ECU, at least one emulated ECU, at least one physical ECU, or a combination thereof. Further still, the plurality of ECUs may include at least one of: Central ECU (CECU), Instrument Cluster (IC) ECU, In-Vehicle Infotainment (IVI) ECU, and Advanced Driver Assistance Systems (ADAS) ECU.

According to embodiments, the change in the software may include a breaking change. Further, the detecting the change in the software may include: obtaining, from a node associated with the software, information of a current status of the software; determining, based on the obtained status information, whether or not the software has changed from a previous version; and based on determining that the software has changed, determining whether or not the change is the breaking change.

According to embodiments, the determining the plurality of test environments may include: creating, based on the obtained test bench, a test job comprises a plurality of tasks; and selecting, based on one or more requirements for executing the plurality of tasks, the plurality of test environments. Further, the performing the cross-domain test may include: assigning one or more tasks of the test job to the plurality of test environments; receiving, from the plurality of test environments, a test result associated with the assigned one or more tasks; and generating, based on the test result associated with the assigned one or more tasks, a test result of the cross-domain test.

According to embodiments, a system for facilitating provisioning of a cross-domain test for testing software of an embedded system may be provided. The system may include: at least one memory storage storing computer-executable instructions; and at least one processor communicatively coupled to the at least one memory storage and configured to execute the computer-executable instructions to: detect a change in the software; obtain a test configuration file associated with the software; obtain, based on the test configuration file, a test bench; determine a plurality of test environments associated with the test bench; and perform the cross-domain test based on the plurality of test environments, wherein the software of the embedded system may include an in-vehicle electronic control unit (ECU), and wherein the plurality of tests environments may include at least one software-in-the-loop (SIL) test environment and at least one hardware-in-the-loop (HIL) test environment.

According to embodiments, the test configuration file may include information of a plurality of ECUs associated with the software and information of a test environment associated with each of the plurality of ECUs. At least a portion of the plurality of ECUs may be associated with one or more nodes different from the software. Further, at least a portion of the plurality of ECUs may be distributed across geographical locations different from the software. Furthermore, the plurality of ECUs may include: at least one virtual ECU, at least one emulated ECU, at least one physical ECU, or a combination thereof. Further still, the plurality of ECUs may include at least one of: Central ECU (CECU), Instrument Cluster (IC) ECU, In-Vehicle Infotainment (IVI) ECU, and Advanced Driver Assistance Systems (ADAS) ECU.

According to embodiments, the change in the software may include a breaking change. Further, the at least one processor may be configured to execute the computer-executable instructions to detect the change in the software by: obtaining, from a node associated with the software, information of a current status of the software; determining, based on the obtained information, whether or not the software has changed from a previous version; and based on determining that the software has changed, determining whether or not the change is the breaking change.

According to embodiments, the at least one processor may be configured to execute the computer-executable instructions to determine the plurality of test environments by: creating, based on the obtained test bench, a test job comprises a plurality of tasks; and selecting, based on one or more requirements for executing the plurality of tasks, the plurality of test environments. Further, the at least one processor may be configured to execute the computer-executable instructions to perform the cross-domain test by: assigning one or more tasks of the test job to the plurality of test environments; receiving, from the plurality of test environments, a test result associated with the assigned one or more tasks; and generating, based on the test result associated with the assigned one or more tasks, a test result of the cross-domain test.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture for facilitating provisioning of a cross-domain test, according to one or more embodiments;

FIG. 2 illustrates a block diagram of example components of a test management system, according to one or more embodiments;

FIG. 3 illustrates a flow diagram of an example method for facilitating provisioning of a cross-domain test, according to one or more embodiments;

FIG. 4 illustrates a flow diagram of an example use case associated with operation S310 in FIG. 3, according to one or more embodiments;

FIG. 5 illustrates a flow diagram of an example method for selecting a plurality of test environments and for performing a cross-domain test thereon, according to one or more embodiments; and

FIG. 6 illustrates a flow diagram of an example use case associated with one or more operations of the method in FIG. 5, according to one or more embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Example embodiments consistent with the present disclosure provide methods, systems, and apparatuses for facilitating provisioning of a cross-domain test for testing one or more software of an embedded system, without geographic or locational restriction.

Specifically, methods, systems, apparatuses, or the like, of example embodiments may automatically detect one or more changes in one or more software of the embedded system and may automatically configure and execute the cross-domain test for testing the one or more software accordingly. According to embodiments, methods, systems, apparatuses, or the like, of example embodiments may automatically determine a plurality of test environments and perform the cross-domain test based on the plurality of test environments. In some implementations, upon detecting the one or more changes, one or more configuration files associated with the one or more software may be obtained, and a test bench may be obtained based on the one or more configuration files. Accordingly, the plurality of test environments may be determined based on the test bench, and the methods, systems, apparatuses, or the like, of example embodiments may automatically assign one or more tasks to the plurality of test environments for executing the cross-domain test, regardless of where the plurality of test environments and the components involved in the testing are located.

To this end, methods, systems, and apparatuses consistent with the example embodiments of the present disclosure automatically facilitate provisioning of appropriate test environments for a cross-domain test when required, without geographic restriction. The users may remotely configure one or more conditions for triggering the cross-domain test, and the execution of the cross-domain test may be automatically triggered based thereon, without requiring the users to physically visit the testing facility. Furthermore, a breaking change(s) may be quickly and easily discovered and remedied, and a reconfigured cross-domain test may be instantly re-initiated or re-executed when required.

Ultimately, example embodiments of the present disclosure enable the development of the software to be performed more efficiently, the burden of the users may be significantly reduced, the development time may be significantly reduced, and the cost and efforts for planning physical visit or travelling plan to physical testing facility may be significantly reduced.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure are provided in the following.

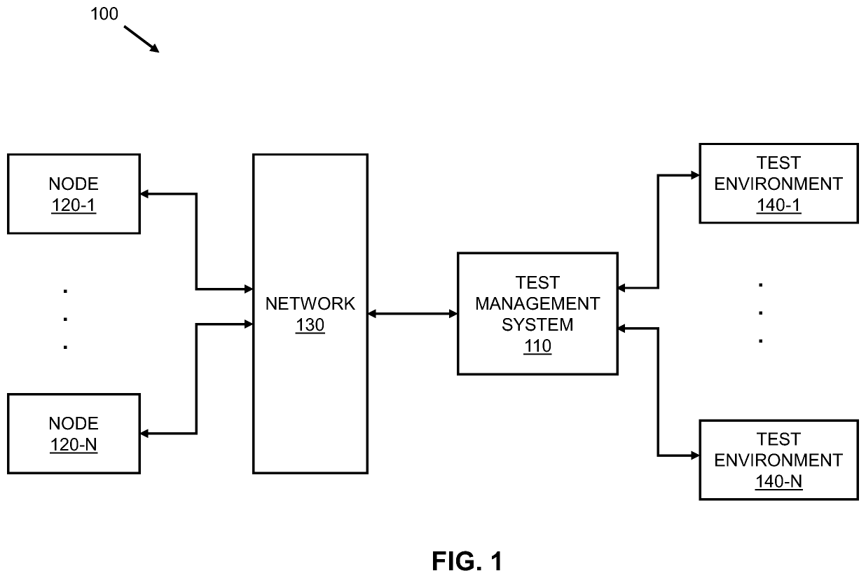

FIG. 1 illustrates a block diagram of an example system architecture 100 for facilitating provisioning of a cross-domain test, according to one or more embodiments. As illustrated in FIG. 1, system architecture 100 may include a test management system 110, a plurality of nodes 120-1 to 120-N, a network 130, and a plurality of test environments 140-1 to 140-N.

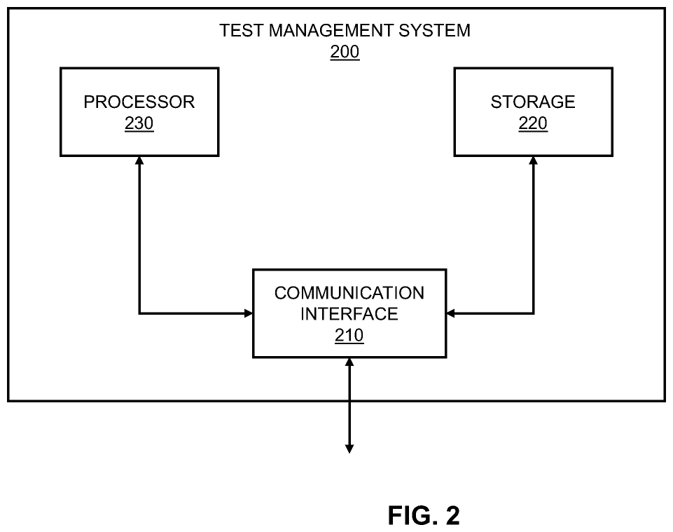

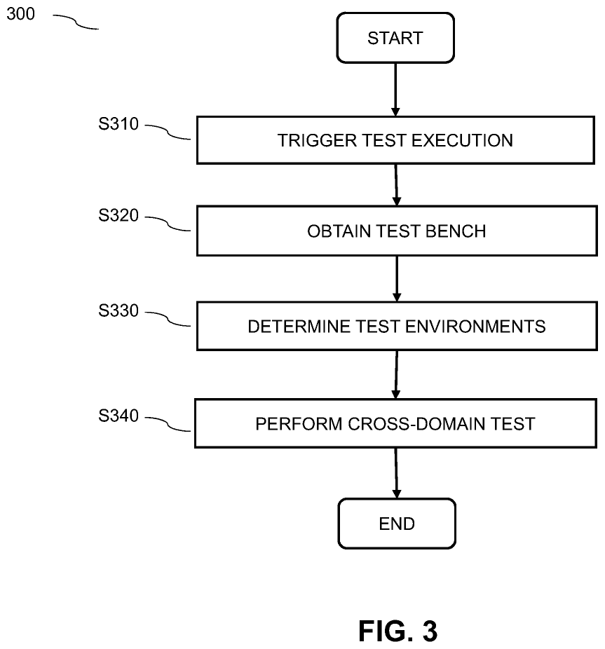

In general, the test management system 110 may be communicatively coupled to the plurality of nodes 120-1 to 120-N(via the network 130) and to the plurality of test environments 140-1 to 140-N, and may be configured to utilize said plurality of test environments to provide a cross-domain test on one or more components (e.g., virtual ECU, physical ECU, etc.) associated with said plurality of nodes. Descriptions of example components which may be included in the test management system 110 are provided in below with reference to FIG. 2, and one or more operations performable by the test management system 110, as well as the associated use cases, are provided in below with reference to FIG. 3 to FIG. 6.

Each of the plurality of nodes 120-1 to 120-N may include one or more devices, equipment, systems, or any other suitable components which may receive, host, store, deploy, process, provide and/or the like, one or more components which constitute a system.

As an example, the node 120-1 may include a device or an equipment (e.g., a personal computer, a server or a server cluster, a workstation, etc.) which may be utilized for building, storing, executing, simulating, executing, or the like, one or more computer executable software applications, such as one or more virtualized ECUs, one or more emulated ECUs, and/or any other suitable software-based components (e.g., vehicle model, Data Communications Module (DCM) model, Heating, Ventilation, and Air Conditioning (HVAC) model, etc.), of a vehicle system. As another example, the node 120-1 may include or associated with one or more hardware components, such as one or more fully developed physical ECUs, one or more partially developed physical ECUs, one or more vehicle hardware (e.g., powertrain, etc.), or the like. Additionally or alternatively, the node(s) may include one or more retarget equipment.

According to embodiments, one or more of the plurality of nodes 120-1 to 120-N may include one or more interfaces, each of which may be configured to communicatively coupled the associated node to the test management system 110. For instance, the one or more of the plurality of nodes may include a programmatic interface, a hardware interface, a software interface (e.g., application program interface (API), etc.), and/or the like.

According to embodiments, at least a portion of the plurality of nodes 120-1 to 120-N is located at one or more geographical locations different from the test management system 110, different from another portion of the plurality of nodes, and/or different from the plurality of test environments 140-1 to 140-N.

The network 130 may include one or more wired and/or wireless networks, which may be configured to couple the plurality of nodes 120-1 to 120-N to the test management system 110. For example, the network 1030 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

According to embodiments, the network 130 may include a virtual network, which may include one or more physical network components (e.g., Ethernet, WiFi module, telecommunication network hardware, etc.) with one or more virtualized network functions (e.g., a control area network (CAN) bus, etc.) implemented therein. Additionally or alternatively, the network 130 may include at least one parameters network. According to embodiments, the network 130 may also be configured to couple the test management system 110 (or one or more components included therein) to other components, such as to the plurality of test environments 140-1 to 140-N, to one or more devices or equipment of a user (e.g., a tester, etc.), or the like.

The plurality of test environments 140-1 to 140-N may include at least one software-based test environment and/or at least one hardware-based test environment. According to embodiments, the at least one software-based test environment may include at least one software-in-the-loop (SIL) test environment, at least one virtual ECU (V-ECU) test environment, at least one model-in-the-loop (MIL) test environment, at least one processor-in-the-loop (PIL) test environment, and/or the like. According to embodiments, the at least one hardware-based test environment may include at least one hardware-in-the-loop (HIL) test environment. Each of the test environments 140-1 to 140-N may be communicatively coupled to the test management system 110 and may provide to and receive from the test management system 110 one or more signals, information, data, or the like.

Generally, the at least one hardware-based test environment may be configured to manage one or more tasks associated with one or more physical hardware components, such as (but are not limited to) executing or simulating a test, scheduling a test execution, and the like, which involve the one or more physical hardware components. For instance, the at least one hardware-based test environment may be communicatively coupled to one or more developed (or partially developed) hardware/physical components and may simulate reality environments or actual use cases to test or assess the one or more hardware/physical components therewith.

By way of example, a physical engine ECU may be developed and be tested before being embedded to a vehicle. In such example, instead of testing the engine ECU with an actual engine, the at least one hardware-based test environment may perform a simulation of the engine that interacts with the engine ECU. As another example, an in-vehicle feature may include functionalities of a software-based ECU (e.g., virtual ECU, emulated ECU, etc.) and a hardware-based ECU, and thus the at least one hardware-based test environment may be configured to interoperate with the at least one software-based test environment via the test management system 110, so as to provide a cross-domain test therefor (e.g., the at least one hardware-based test environment may execute task(s) associated with the hardware-based ECU and the at least one software-based test environment may execute tasks(s) associated with the software-based ECU, and the results associated therewith may be collectively provided to the test management system 110 and be further processed thereafter).

On the other hand, the at least one software-based test environment may be configured to manage one or more tasks associated with one or more software components, such as (but are not limited to) executing or simulating a test, scheduling a test execution, and the like. Unlike the hardware-based test environment which is communicatively coupled to one or more physical/hardware components and perform testing/simulation thereon, the software-based test environment may simply obtain or receive one or more software components and perform software-based testing/simulation thereon. Simply put, the software-based test environment may be produced, deployed, and run in any suitable computing device or environment, without requiring a connection to the physical/hardware components to-be tested like the hardware-based test environment does.

According to embodiments, the one or more software components, which may be tested with the at least one software-based test environment, may include at least one virtualized ECU and at least one emulated (or simulated) ECU. In this regard, the at least one virtualized ECU may be different from the at least one emulated ECU in that the virtualized ECU may contain application software, programming codes, functional algorithms, or the like, that define a final ECU (e.g., in terms of design, development, production, etc.), while the emulated ECU may contain application software, programming codes, functional algorithms, or the like, that define a generic or non-final ECU. Further, the at least one virtualized ECU and/or the at least one emulated ECU may include at least one of: Central ECU (CECU), Instrument Cluster (IC) ECU, In-Vehicle Infotainment (IVI) ECU, Advanced Driver Assistance Systems (ADAS) ECU, chassis ECU, powertrain ECU, vehicle body ECU, and any other suitable type of ECU associated with a vehicle.

Additionally or alternatively, the one or more software components may include one or more software models, such as: at least one simulated environment condition model (e.g., road condition model, traffic condition model, weather condition model, etc.), at least one vehicle-related model (e.g., DCM model, HVAC model, etc.), and/or the like.

According to embodiments, the software-based test environment may simultaneously perform a plurality of tasks (e.g., multiple testing, multiple simulations, etc.). For instance, the software-based test environment may perform multiple testing/simulations for one software component (e.g., one virtualized ECU, etc.) in parallel, may perform one testing/simulation for multiple software components in parallel, and/or the like. Further, the software-based test environment and the hardware-based test environment may simultaneously perform a plurality of tasks (e.g., multiple testing, multiple simulations, etc.). For instance, the software-based test environment may perform one or more testing/simulations for one or more software components, while at the same time the hardware-based test environment may perform one or more testing/simulations for one or more hardware components (e.g., physical ECU, etc.).

The plurality of test environments 140-1 to 140-N may be hosted in or communicatively coupled to one or more test servers. According to embodiments, one or more of the plurality of test environments 140-1 to 140-N may be deployed, hosted, or the like, in one or more of the plurality of nodes 120-1 to 120-N. For instance, a software-based test environment may be deployed and run on one or more of the plurality of nodes 120-1 to 120-N. Alternatively or additionally, one or more of the plurality of test environments 140-1 to 140-N may be communicatively coupled (e.g., via wired coupling, wireless coupling, etc.) to one or more of the plurality of nodes 120-1 to 120-N. For instance, a hardware-based test environment may be communicatively coupled to a node associated with a physical ECU (e.g., fully developed hardware ECU, partially developed hardware ECU, etc.). In that case, the one or more of the plurality of test environments may be communicatively coupled to the test management system 110 via the network 130, as described above.

To this end, it can be understood that the one or more software components and/or the one or more hardware components (i.e., the component to be tested in the plurality of test environment 140-1 to 140-N) described hereinabove may be associated with (e.g., deployed in, communicatively coupled to, etc.) one or more of the plurality of nodes 120-1 to 120-N, and the test management system 110 may be configured to utilize the plurality of nodes and the plurality of test environments for facilitating provisioning of a cross-domain test.

Referring next to FIG. 2, which illustrates a block diagram of example components of a test management system 200, according to one or more embodiments. Test management system 200 may corresponds to the test management system 110 described above with reference to FIG. 1, thus the features described herein with reference to systems 110 and 200 may be applicable to one another, unless being explicitly described otherwise.

As illustrated in FIG. 2, the test management system 200 may include at least one communication interface 210, at least one storage 220, and at least one processor 230, although it can be understood that the test management system 200 may include more or less components than as illustrated, and/or the components included therein may be arranged in any a manner different from as illustrated, without departing from the scope of the present disclosure.

The communication interface 210 may include a transceiver-like component (e.g., a transceiver, a separate receiver and transmitter, etc.) that enables the test management system 200 (or one or more components included therein) to communicate with one or more components external to the test management system 200, such as via a wired connection, a wireless connection, or a combination of wired and wireless connections. For instance, the communication interface 210 may couple the test management system 200 (or one or more components included therein) to a plurality of test environments (e.g., test environments 140-1 to 140-N in FIG. 1, etc.) to thereby enable them to communicate and to interoperate with each. As another example, communication interface 210 may couple the test management system 200 (or one or more components included therein) to a plurality of nodes (e.g., nodes 120-1 to 120-N in FIG. 1, etc.) to thereby enable them to communicate and to interoperate with each other. Similarly, the communication interface 210 may enable the components of the test management system 200 to communicate with each other. For instance, the communication interface 210 may couple the storage 220 to the processor 230 to thereby enable them to communicate and to interoperate with each other.

According to embodiments, the communication interface 210 may include a hardware-based interface, such as a bus interface, an Ethernet interface, an optical interface, a coaxial interface, an infrared interface, a radio frequency (RF) interface, a universal serial bus (USB) interface, a Wi-Fi interface, a cellular network interface, a software interface, or the like. According to embodiments, communication interface 210 may include at least one controller area network (CAN) bus configurable to communicatively couple the components of the test management system 200 (e.g., storage 220, processor 230, etc.) to a plurality of nodes (e.g., nodes 120-1 to 120-N) and/or to a plurality of test environments (e.g., test environments 140-1 to 140-N). Additionally or alternatively, the communication interface 210 may include a software-based interface, such as an application programming interface (API), a virtualized network interface (e.g., virtualized CAN bus, etc.), or the like.

The at least one storage 220 may include one or more storage mediums suitable for storing data, information, and/or computer-readable/computer-executable instructions therein. According to embodiments, the storage 220 may include a random access memory (RAM), a read only memory (ROM), and/or another type of dynamic or static storage device (e.g., a flash memory, a magnetic memory, and/or an optical memory) that stores information and/or instructions for use by the processor 230. Additionally or alternatively, the storage 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 220 may act as a centralized library and may be configured to store information to-be utilized by the processor 230 for managing one or more testing (e.g., cross-domain test, etc.). For instance, the storage 220 may be configured to store one or more parameters or configurations predefined or predetermined by one or more users (e.g., tester(s) associated with one or more nodes, etc.), such as: a test cycle, one or more test conditions, one or more configuration files, and/or the like. Further, the storage 220 may be configured to store information associated with capability and/or availability of each of the plurality of test environments communicatively coupled to the test management system, such as: capacity information of a test server (or any other suitable node) in which the test environment is deployed/hosted, processing power of simulator of the test environment (e.g., HIL simulator, SIL simulator, etc.), historical test results, usage cost, processing/testing speed (or parameters by which processing/testing speed can be determined), and/or the like. Furthermore, the storage 220 may store computer-readable instructions which, when being executed by one or more processors (e.g., processor 230), causes the one or more processors to perform one or more actions described herein.

The at least one processor 230 may include one or more processors capable of being programmed or configured to perform a function or an operation for facilitating provisioning of a cross-domain test. For instance, the processor 230 may be configured to execute computer-readable instructions stored in a storage medium (e.g., storage 220, etc.) to thereby perform one or more actions or one or more operations described herein.

According to embodiments, the processor 230 may be configured to receive (e.g., via the communication interface 210, etc.) one or more signals defining one or more instructions for performing one or more operations. Further, the processor 230 may be implemented in hardware, firmware, or a combination of hardware and software. The processor 230 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 230 may be configured to execute computer-executable instructions stored in at least one memory storage (e.g., storage 220) to thereby perform one or more operations for managing one or more testing of one or more components (e.g., software and/or hardware components deployed in or associated with one or more of the plurality of nodes).

Referring to FIG. 3, which illustrates a flow diagram of an example method 300 for facilitating provisioning of a cross-domain test, according to one or more embodiments. Method 300 may be performed by at least one processor (e.g., processor 230) of the test management system for testing one or more software associated with an embedded system of a vehicle (e.g., in-vehicle ECU, etc.).

At operation S310, the at least one processor of the test management system may be configured to determine whether or not a test execution should be triggered. For instance, the at least one processor may determine whether or not one or more conditions for executing a testing are satisfied. The one or more conditions may be predefined by one or more users (e.g., user associated with one or more of the plurality of nodes, etc.) and may be stored in one or more storage mediums (e.g., storage 220, etc.). By way of example, the one or more conditions may include: one or more test requirements are satisfied/violated, one or more thresholds are achieved, one or more changes in a software and/or one or more associated components (e.g., software/hardware component(s) in the node(s), etc.) are detected, and the like.

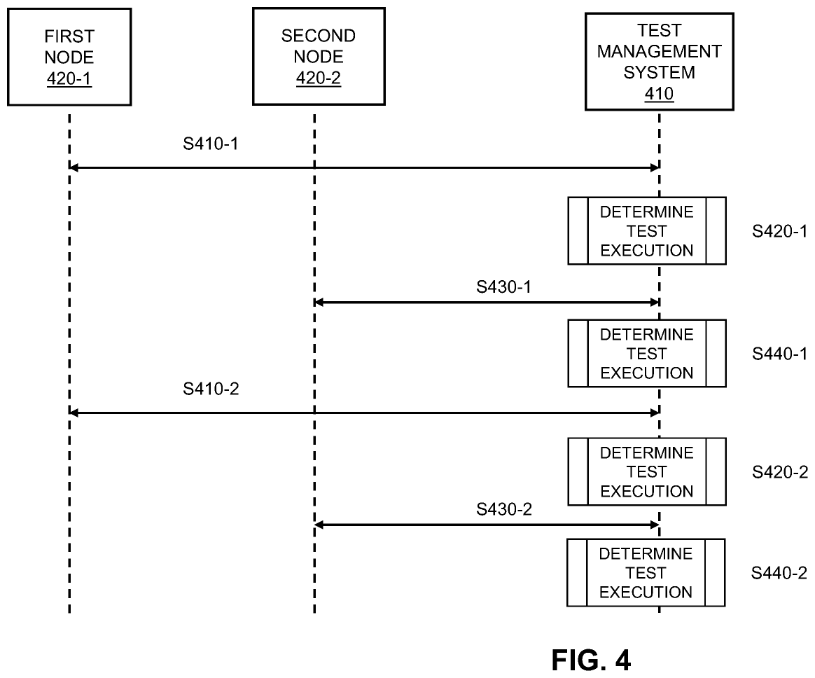

According to embodiments, the at least one processor may determine whether or not the one or more conditions for executing the testing are satisfied by detecting a change in a software (e.g., a virtual ECU, etc.). For instance, the at least one processor may determine whether or not the software has changed from a previous version, and may determine whether or not the change is a breaking change. Descriptions of an example use case associated with operation S310 are provided in below with reference to FIG. 4.

Accordingly, based on determining that the one or more conditions for executing the testing are satisfied, the at least one processor may determine that a test execution should be triggered, and the method 300 may proceed to operation S320.

At operation S320, the at least one processor may be configured to obtain a test bench. In general, a test bench in software testing may refer to information or parameters, such as a set of procedures, a collection of test scenarios, or the like, which provide a simulation or configuration of required testing inputs. For instance, a test bench for testing an ECU may include information or parameters for simulating a load for testing the ECU, for simulating one or more ECUs associated with the ECU, for simulating one or more environment conditions (e.g., road condition, weather condition, etc.), or the like. According to embodiments, the test bench may include a general test bench which defines configurations of test environment(s) for normal operation, and may include an instrumented test bench which defines configurations, conditions and/or services (in addition to the general test bench) for testing specific feature or circumstances.

According to embodiments, at operation S320, the at least one processor may obtain one or more test configuration files associated with the component(s) under-test (e.g., software component, hardware component, etc.), and may obtain the test bench based on the one or more test configuration files.

The one or more test configuration files may include information or parameters, such as mappings of functionalities of the component(s) and the type of test environment associated therewith (e.g., function A of the first ECU should be tested with a software-based test environment, function B of the first ECU should be tested with a hardware-based test environment, etc.), resources (e.g., computing power, memory, etc.) required for testing the functionality(s) of the component, load information associated with the functionality(s), or the like, which define one or more test configurations.

According to embodiments, the one or more test configuration files may include information of a plurality of ECUs (e.g., virtual ECU, emulated ECU, physical ECU, etc.) associated with the component(s) under-test (e.g., the software). Said information may include source codes, algorithms, functionalities, or the like, of the plurality of ECUs, and may include information of a test environment associated with each of the plurality of ECUs. In some implementations, at least a portion of the plurality of ECUs may be distributed across geographical locations different from the component under-test. Alternatively or additionally, the portion of the plurality of ECUs may be associated with (e.g., hosted/deployed in, communicatively coupled to, etc.) one or more nodes different from a node of the component under-test. Further, the plurality of ECUs may include at least one of: Central ECU (CECU), Instrument Cluster (IC) ECU, In-Vehicle Infotainment (IVI) ECU, Advanced Driver Assistance Systems (ADAS) ECU, and any other suitable type of ECU.

Accordingly, the at least one processor may obtain, based on the one or more test configuration files, the test bench. According to embodiments, the test bench may be pre-generated and pre-stored in one or more storage mediums (e.g., storage 220, external server, etc.), and the at least one processor may obtain (based on the one or more test configuration files) the test bench from the one or more storage mediums at operation S320. Alternatively, the at least one processor may generate, based on the one or more test configuration files, the test bench in real-time or near real-time at operation S320. According to embodiments, the at least one processor may obtain or generate a replica of components associated with the component under-test (e.g., cloned version of ECUs associated with the component under-test, etc.) and include the replica into the test bench.

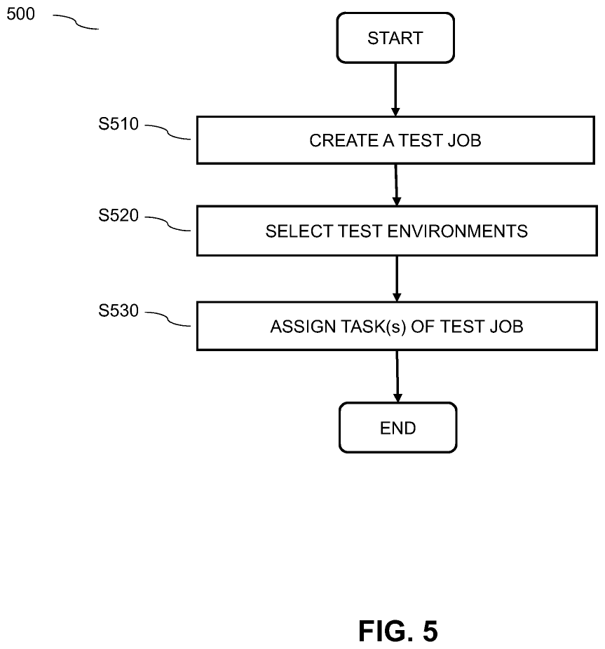

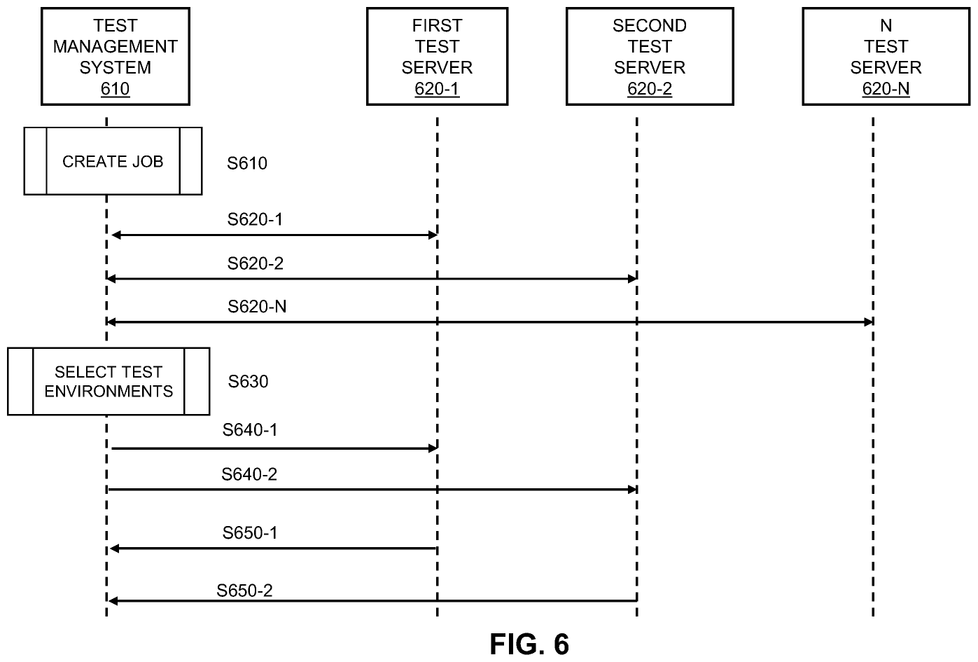

Upon obtaining the test bench, the method 300 may proceed to operation S330, at which the at least one processor of the test management system may be configured to determine a plurality of test environments associated with the test bench. The plurality of tests environments may include at least one software-based test environment (e.g., a software-in-the-loop (SIL) test environment) and at least one hardware-based test environment (e.g., hardware-in-the-loop (HIL) test environment), in a similar manner as described above with reference to the plurality of test environments 140-1 to 140-N in FIG. 1. Subsequently, upon determining the plurality of test environments, the method 300 may proceed to operation S340, at which the at least one processor may be configured to perform the cross-domain test based on the plurality of test environments. Descriptions of example operations associated with operations S330 and S340, as well as an example use case associated therewith, are provided below with reference to FIG. 5 and FIG. 6.

Referring next to FIG. 4, which illustrates a flow diagram of an example use case associated with operation S310 in FIG. 3, according to one or more embodiments. In this example use case, a test management system 410 is configured to continuously (or periodically) monitor the status of component(s) deployed in or associated with a first node 420-1 and a second node 420-2 according to a test cycle associated with each of the first node 420-1 and the second node 420-2, and to determine whether or not a test execution should be triggered for testing said component(s).

In this regard, it can be understood that the test management system 410 in FIG. 4 may corresponds to the test management system 110 in FIG. 1 and the test management system 200 in FIG. 2, and the first node 420-1 and the second node 420-2 in FIG. 4 may corresponds to a portion of the plurality of nodes 120-1 to 120-N in FIG. 1. Further, it can be understood that the test management system 410 may include at least one processor (e.g., processor 230) as described above with reference to FIG. 2, and one or more operations in FIG. 4 may be performed by the at least one processor. Thus, redundant descriptions associated therewith may be omitted in below for conciseness.

As illustrated in FIG. 4, at operations S410-1 and S410-2, the at least one processor of the test management system 410 may be configured to communicate with the first node 420-1. According to embodiments, the at least one processor may send, to the first node 420-1, a query or a request (e.g., via API calls, etc.) for information of current status of one or more components associated with the first node 420-1 (e.g., a software component deployed in or hosted in the first node 420-1, a hardware component communicatively coupled to the first node 420-1, etc.). Accordingly, the first node 420-1 may provide the requested information to the at least one processor of the test management system 410.

According to embodiments, the at least one processor may continuously (or periodically) perform operations S410-1 and S410-2 according to a first test cycle associated with the first node 420-1 and/or associated with the one or more components associated therewith. The first test cycle may be predetermined by one or more users associated with the first node 420-1 (e.g., a manager of the first node 420-1, a developer of a software component deployed in the first node 420-1, etc.), and the first test cycle may be pre-stored in one or more storage mediums (e.g., a storage of the test management system 410, a server external from the test management system 410, etc.).

By way of example, the first test cycle may define that a first component associated with the first node 420-1 should be checked on a time interval of every 5 minutes, every 1 hour, every 1 day, or the like. Accordingly, the at least one processor of the test management system 410 may perform operations S410-1 and S410-2 every 5 minutes, every 1 hour, every 1 day, or the like, so as to obtain from the first node 420-1 the latest status information of the first component. Further, the at least one processor may perform operation S410-2 after 5 minutes (or other suitable time interval defined by the first test cycle) from the performing of operation S410-1, or the like.

It is contemplated that, at operations S430-1 and S430-2, the at least one processor of the test management system 410 may be configured to communicate with the second node 420-2 to request for information of current status of one or more components associated with the second node 420-2, according to a second test cycle predetermined by one or more users associated with the second node 420-2, in a similar manner as described hereinabove with reference to operations S410-1 and S410-2.

Further, it can be understood that the second test cycle (on which the at least one processor perform the operations S430-1 and S430-2) may be similar to or different from the first test cycle (on which the at least one processor perform the operations S410-1 and S410-2). Further, it can be understood that the at least one processor may be configured to perform the communications with the first node 420-1 (operations S410-1 and S410-2) and the communications with the second node 420-2 (operations S430-1 and S430-2) in any suitable sequence. For instance, the at least one processor may simultaneously perform the communications with the first node 420-1 and with the second node 420-2 (e.g., operations S410-1 and S430-1 may be performed in parallel, operations S410-2 and S430-2 may be performed in parallel, etc.), may perform the communications with the second node 420-2 before performing the communications with the first node 420-1 and (e.g., operation S430-1 may be performed before operation S410-1, etc.), or the like, without departing from the scope of the present disclosure.

Referring still to FIG. 4, upon communicating with the first node 420-1 and the second node 420-2, the at least one processor of the test management system 410 may be configured to determine, based on the information or data obtained from the first node 420-1 and the second node 420-2, whether or not a test execution should be triggered on an associated component(s).

For instance, at operation S420-1, the at least one processor may determine whether or not one or more conditions for executing a testing are satisfied. By way of example, the at least one processor may determine whether or not a component in the first node 420-1 has changed (from a previous version), and may determine whether or not a breaking change has occurred based on determining that the component has changed.

In this regard, a “breaking change” may refer to a modification on a software (or one or more components associated therewith) that causes existing functionality of the software to no longer work as intended or no longer stable. Further, the breaking change may be a change that alters the behavior of the software in a way that it affects other parts (e.g., other software components, other hardware components, etc.) associated with the software, leading to a failure in the software. To this end, the condition(s) for determining the breaking change may be predefined by the user(s) associated with the component under-test, may be predefined by other user(s) associated with the component under-test (e.g., user(s) associated with other ECUs associated with the component under-test, etc.), and/or the like.

Accordingly, at operations S420-1, upon detecting a change(s) in the component under-test, the at least one processor may determine (based on the one or more predefined conditions) whether or not the change(s) is the breaking change, and may determine that a test execution for the component under-test is required based on determining that the change(s) is the breaking change.

It can be understood that, in addition to or in alternative of determining the breaking change, the at least one processor may determine whether or not any other condition(s) have been satisfied so as to determine whether or not the test execution should be triggered. For instance, the at least one processor may determine whether or not a performance of the associated node (e.g., first node 420-1) has degraded, whether or not a pre-set test execution schedule is reached, or the like, and may determine whether or not the test execution should be triggered based thereon. It can also be understood that the at least one processor of the test management system may be configured to perform operations S440-1, S420-2, and S440-2, in a similar manner as described above with reference to operation S420-1.

To this end, the at least one processor of the test management system 410 may continuously (or periodically) determine whether or not a test execution should be triggered for testing one or more components associated with one or more nodes, in an automated manner.

Referring next to FIG. 5, which illustrates a flow diagram of an example method 500 for selecting a plurality of test environments and for performing a cross-domain test thereon, according to one or more embodiments. One or more operations of method 500 may be part of operations S330 and S340 in FIG. 3, and may be performed by at least one processor (e.g., processor 230) of the test management system.

At operation S510, the at least one processor of the test management system may be configured to create a test job. For instance, the at least one processor may create, based on a test bench (e.g., obtained at operation S320), a test job containing a plurality of tasks, each of which may contain information (e.g., requirements, etc.) associated with a to-be executed testing.

By way of example, assuming that a cross-domain test is required to-be executed for testing a changed/modified software (e.g., a modified virtual ECU) under a software-based test environment (e.g., SIL test environment) and under a hardware-based test environment (e.g., a HIL test environment), the at least one processor may create a cross-domain test job containing a plurality of tasks, each of which contains information, such as runtime information, information of required hardware resource (e.g., type of required physical ECU, etc.), information of required software resource (e.g., CPU power, memory, etc.), information of replica of component(s), and/or the like, which may be utilized by the at least one processor to determine an optimal software-based test environment and an optimal hardware-based test environment for performing the cross-domain test.

Upon creating the test job, the method 500 may proceed to operation S520, at which the at least one processor of the test management system may be configured to select, based on the created test job, a plurality of test environments for executing the test.

By way of example, assuming that a cross-domain test job is created (as described above with reference to operation S510), the at least one processor may determine, based on one or more requirements for executing the tasks of the cross-domain test job, the test environment requirements for executing each task of the test job. Subsequently, the at least one processor may select, from among a plurality of test environments communicatively coupled to the test management system (e.g., the plurality of test environments 140-1 to 140-N), appropriate or optimal test environments for executing the tasks of the cross-domain test job.

For instance, the at least one processor may select, from among a plurality of software-based test environments communicatively coupled to the test management system, one or more software-based test environments which is available and which fulfills the required requirements (e.g., software resource requirements, etc.) for executing a software-based testing, and the at least one processor may select, from among a plurality of hardware-based test environments communicatively coupled to the test management system, one or more hardware-based test environments which is available and which fulfills the required requirements (e.g., hardware resource requirements, etc.), or the like.

Upon selecting the test environments, the method 500 may proceed to operation S530, at which the at least one processor of the test management system may be configured to assign one or more tasks to the selected test environments. Accordingly, said test environments may execute the assigned task(s) and provide the execution results to the at least one processor thereafter. Subsequently, the at least one processor may generate (e.g., compile, aggregate, etc.), based on the test results associated with the assigned task(s) and provided by the plurality of test environments, a test result of the cross-domain test.

Referring next to FIG. 6, which illustrates a flow diagram of an example use case associated with one or more operations of the method 500 in FIG. 5, according to one or more embodiments. In this example use case, a test management system 610 is communicatively coupled to a plurality of test servers 620-1 to 620-N, and is configured to select one or more test environments associated with the plurality of test servers to facilitate provisioning of a cross-domain test thereon.

In this regard, it can be understood that the test management system 610 in FIG. 6 may corresponds to the test management system 110 in FIG. 1, the test management system 200 in FIG. 2, or the test management system 410 in FIG. 4, and each of the plurality of test server 620-1 to 620-N may be associated with one or more of the plurality of test environments 140-1 to 140-N in FIG. 1.

Further, it can be understood that the test management system 610 may include at least one processor (e.g., processor 230), and one or more operations in FIG. 6 may be performed by the at least one processor. Furthermore, it can also be understood that one or more operations in FIG. 6 may be performed subsequent to one or more operations in FIG. 3 and FIG. 4.

Referring to FIG. 6, at operation S610, the at least one processor of the test management system 610 may be configured to create a test job. Details of this operation may be similar to those described above with reference to operation S510 in FIG. 5, thus redundant descriptions associated therewith may be omitted below for conciseness.

Upon creating the test job, the at least one processor of the test management system 610 may be configured to communicate with the plurality of test servers 620-1 to 620-N(at operations S620-1 to S620-N, respectively), so as to obtain the information of the associated test environment(s) therefrom.

In the example use case of FIG. 6, the at least one processor may first obtain, from the first test server 620-1, availability information, capability information, and/or any other suitable type of information, of one or more test environments associated with (e.g., hosted/deployed in, communicatively coupled to, etc.) the first test server 620-1 (at operation S620-1). For instance, the at least one processor may generate one or more API calls to request the required information from the first test server 620-1, and may provide the generated API call(s) to the first test server 620-1 (via a communication interface, etc.). Accordingly, the at least one processor may obtain the required information from the remaining test servers 620-2 to 620-N, in a similar manner.

It can be understood that the at least one processor of the test management system 610 may also obtain the required information from the plurality of test servers 620-1 to 620-N in any suitable sequential manner. For instance, the at least one processor may simultaneously perform operations S620-1 and S620-2 to concurrently obtain the required information of the plurality of test environments associated with the first test server 620-1 and the second test server 620-2, may perform operation S620-2 before operation S620-2 to first obtain capability information from the second test server 620-2, or the like.

Upon receiving the required information from the plurality of test servers, at operation S630, the at least one processor of the test management system 610 may be configured to select, from among the plurality of test environments associated with the plurality of test servers, a plurality of test environments which are suitable or optimal for performing one or more tasks of the created test job.

For instance, the at least one processor may select or choose the plurality of test environments according to the required information (e.g., availability, capability, cost, etc.) and the type of test environment (e.g., hardware-based test environment like HIL test environment, software-based test environment like SIL test environment, V-ECU test environment, or the like) required for performing the one or more tasks of the test job.

By way of example, assuming that the test job is a cross-domain test job which includes a first task for testing a virtual ECU A in a SIL test environment with CPU power requirement of X, and a second task for testing the virtual ECU A along with a physical ECU B, or the like, the at least one processor may choose, from among the test servers 620-1 to 620-N, one or more test environments in said test servers which has the sufficient CPU power and is able to perform the SIL test, as required in the first task. Similarly, the at least one processor may choose, from among the test servers 620-1 to 620-N, one or more test environments in said test servers which is associated with physical ECU B and is able to perform the HIL test on the physical ECU B, as required in the second task. It can be understood that the at least one processor may perform any other suitable operations for selecting appropriate test environments for performing the one or more tasks of the created test job, without departing from the scope of the present disclosure.

Upon selecting the plurality of test environments, the at least one processor may be configured to assign or allocate the task(s) of the test job to the respective test environments. In the example use case of FIG. 6, it can be assumed that a first test environment (e.g., SIL test environment) associated with the first test server 620-1 is selected for executing the first task of the test job and a second test environment (e.g., HIL test environment) associated with the second test server 620-2 is selected by the at least one processor for executing the second task of the test job. Accordingly, at operations S640-1 and S640-2, the at least one processor may be configured to assign or allocate the first task and the second task to the first test environment and the second test environment, respectively.

According to embodiments, the at least one processor may be configured to assign or allocate the task(s) of the test job by generating a signal, a message, an instruction, or the like, that includes information of the task (e.g., the schedule for executing the task, the target duration of completion of the task, etc.). According to embodiments in which the task(s) includes testing of other software-components (e.g., other virtual ECU, emulated ECU, software models such as traffic model, etc.), the signal, message, instruction, or the like, generated by the at least one processor may further include a replica (e.g., cloned version of source code, algorithm, etc.) of said other software-components. Subsequently, the at least one processor may provide the generated signal/message/instruction to the test server(s) which is hosting or deploying the selected test environment(s).

In this regard, the at least one processor of the test management system 610 may first assign or allocate a task to the first test environment hosted or deployed in the first test server 620-1 (at operation S640-1), and may then allocate or assign a task to the second test environment hosted or deployed in the second test server 620-2 (at operation S640-2). Alternatively, the at least one processor may allocate the plurality of tasks for simultaneous execution in the first and second test environments. It can be understood that the at least one processor may also allocate or assign the task(s) in any other suitable sequence.

Upon allocating or assigning one or more tasks to the test environment(s), the test environment(s) may execute one or more testing according to the assigned task(s). Subsequently, at operations S650-1 and S650-2, the at least one processor of the test management system 610 may be configured to monitor the performance of the test environment(s), may receive from the test servers one or more test results of assigned task(s), or the like, and may update the associated information in a record file accordingly. For instance, the at least one processor may aggregate the test results provided by the plurality of test environments, and may generate or compile a full, comprehensive test result which represent a test result of the cross-domain test.

As another example, whenever the one or more test results indicate a test run failure (such as due to an exception or a timeout without completing the task within a specified time period), the at least one processor may update the record file so as to not re-assign a similar task to that same test environment in future testing. Similarly, whenever the one or more test results indicate a particular parameter (e.g., time or speed) that is different from that which is estimated from or reflected in the record, the at least one processor may update the record file accordingly to more accurately reflect the latest capability of the corresponding test environment.

Additionally, upon receiving a task failure report or determining a task failure, the at least one processor may be configured to reassign the failed task to another test environment(s). For instance, whenever a task failure is reported due to a timeout, the at least one processor may reassign the task to another test environment in which the associated capability information indicates a higher testing speed than the prior test environment to which the tasks was allocated.

In view of the above, it can be understood that the at least one processor may be configured to assign one or more tasks based on test results of previous tests. For instance, a first series of tests or simulations is executed to test a software component (e.g., a virtual ECU), and the source code of the software component is subsequently updated. In this regard, the at least one processor may optimize (e.g., shorten the test run time, etc.) the task assignments for testing the software component with updated source code in a second series of tests or simulations, based on the results of the first series of tests or simulations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method, implemented by at least one processor, for facilitating provisioning of a cross-domain test for testing software of an embedded system, the method comprising;
detecting a change in the software;
obtaining a test configuration file associated with the software;
obtaining, based on the test configuration file, a test bench;
determining a plurality of test environments associated with the test bench; and
performing the cross-domain test based on the plurality of test environments,
wherein the software of the embedded system comprises an in-vehicle electronic control unit (ECU), and
wherein the plurality of tests environments comprises at least one software-in-the-loop (SIL) test environment and at least one hardware-in-the-loop (HIL) test environment.

2. The method according to claim 1, wherein the change in the software comprises a breaking change.

3. The method according to claim 1, wherein the test configuration file comprises information of a plurality of ECUs associated with the software and information of a test environment associated with each of the plurality of ECUs.

4. The method according to claim 3, wherein at least a portion of the plurality of ECUs is associated with one or more nodes different from the software.

5. The method according to claim 3, wherein at least a portion of the plurality of ECUs is distributed across geographical locations different from the software.

6. The method according to claim 3, wherein the plurality of ECUs comprises: at least one virtual ECU, at least one emulated ECU, at least one physical ECU, or a combination thereof.

7. The method according to claim 3, wherein the plurality of ECUs comprises at least one of: Central ECU (CECU), Instrument Cluster (IC) ECU, In-Vehicle Infotainment (IVI) ECU, and Advanced Driver Assistance Systems (ADAS) ECU.

8. The method according to claim 2, wherein the detecting the change in the software comprises:
obtaining, from a node associated with the software, information of a current status of the software;
determining, based on the obtained status information, whether or not the software has changed from a previous version; and
based on determining that the software has changed, determining whether or not the change is the breaking change.

9. The method according to claim 1, wherein the determining the plurality of test environments comprises:
creating, based on the obtained test bench, a test job comprises a plurality of tasks; and
selecting, based on one or more requirements for executing the plurality of tasks, the plurality of test environments.

10. The method according to claim 9, wherein the performing the cross-domain test comprises:
assigning one or more tasks of the test job to the plurality of test environments;
receiving, from the plurality of test environments, a test result associated with the assigned one or more tasks; and
generating, based on the test result associated with the assigned one or more tasks, a test result of the cross-domain test.

11. A system for facilitating provisioning of a cross-domain test for testing software of an embedded system, the system comprising:
at least one memory storage storing computer-executable instructions; and
at least one processor communicatively coupled to the at least one memory storage and configured to execute the computer-executable instructions to:
detect a change in the software;
obtain a test configuration file associated with the software;
obtain, based on the test configuration file, a test bench;
determine a plurality of test environments associated with the test bench; and
perform the cross-domain test based on the plurality of test environments,
wherein the software of the embedded system comprises an in-vehicle electronic control unit (ECU), and
wherein the plurality of tests environments comprises at least one software-in-the-loop (SIL) test environment and at least one hardware-in-the-loop (HIL) test environment.

12. The system according to claim 11, wherein the change in the software comprises a breaking change.

13. The system according to claim 11, wherein the test configuration file comprises information of a plurality of ECUs associated with the software and information of a test environment associated with each of the plurality of ECUs.

14. The system according to claim 13, wherein at least a portion of the plurality of ECUs is associated with one or more nodes different from the software.

15. The system according to claim 13, wherein at least a portion of the plurality of ECUs is distributed across geographical locations different from the software.

16. The system according to claim 13, wherein the plurality of ECUs comprises: at least one virtual ECU, at least one emulated ECU, at least one physical ECU, or a combination thereof.

17. The system according to claim 13, wherein the plurality of ECUs comprises at least one of: Central ECU (CECU), Instrument Cluster (IC) ECU, In-Vehicle Infotainment (IVI) ECU, and Advanced Driver Assistance Systems (ADAS) ECU.

18. The system according to claim 2, wherein the at least one processor is configured to execute the computer-executable instructions to detect the change in the software by:
obtaining, from a node associated with the software, information of a current status of the software;
determining, based on the obtained information, whether or not the software has changed from a previous version; and
based on determining that the software has changed, determining whether or not the change is the breaking change.

19. The system according to claim 11, wherein the at least one processor is configured to execute the computer-executable instructions to determine the plurality of test environments by:
creating, based on the obtained test bench, a test job comprises a plurality of tasks; and
selecting, based on one or more requirements for executing the plurality of tasks, the plurality of test environments.

20. The system according to claim 19, wherein the at least one processor is configured to execute the computer-executable instructions to perform the cross-domain test by:
assigning one or more tasks of the test job to the plurality of test environments;
receiving, from the plurality of test environments, a test result associated with the assigned one or more tasks; and
generating, based on the test result associated with the assigned one or more tasks, a test result of the cross-domain test.
